(19) United States
(12) Patent Application Publication
(10) Pub. No.: US 2022/0301131 A1
(43) Pub. Date: Sep. 22, 2022

(54) METHOD AND APPARATUS FOR GENERATING SAMPLE IMAGE

(71) Applicant: BEIJING BAIDU NETCOM SCIENCE TECHNOLOGY CO., LTD., Beijing (CN)

(72) Inventors: Jingwei LIU, Beijing (CN); Yi GU, Beijing (CN); Xuhui LIU, Beijing (CN); Xiaodi WANG, Beijing (CN); Shumin HAN, Beijing (CN); Yuan FENG, Beijing (CN); Ying XIN, Beijing (CN); Chao LI, Beijing (CN); Bin ZHANG, Beijing (CN); Honghui ZHENG, Beijing (CN); Xiang LONG, Beijing (CN); Yan PENG, Beijing (CN); Errui DING, Beijing (CN); Yunhao WANG, Beijing (CN)

(21) Appl. No.: 17/743,057

(22) Filed: May 12, 2022

(30) Foreign Application Priority Data
Jul. 19, 2021 (CN) 202110815305.8

(51) Int. Cl. G06T 5/50; G06T 7/13

(52) U.S. Cl. CPC G06T 5/50; G06T 7/13; G06T 2207/20221; G06T 2207/20112

(57) ABSTRACT

A method for generating a sample image includes: obtaining an initial image size of an initial image; obtaining a plurality of reference images by processing the initial image based on different reference processing modes; obtaining an image to be processed by fusing the plurality of reference images; and determining a target sample image from images to be processed based on the initial image size.

### CROSS-REFERENCE TO RELATED APPLICATION

This application is based upon and claims priority to Chinese Patent Application No. 202110815305.8, filed on Jul. 19, 2021, the entire content of which are incorporated herein by reference.

### TECHNICAL FIELD

The disclosure relates to the technical field of artificial intelligence (AI), specially to the technical fields of computer vision and deep learning, and in particular to a method for generating a sample image, an apparatus for generating a sample image, an electronic device and a storage medium.

### BACKGROUND

Artificial intelligence (AI) is a study of making computers to simulate certain thinking processes and intelligent behaviors of humans (such as learning, reasoning, thinking and planning), which has both hardware-level technologies and software-level technologies. AI hardware technologies generally include technologies such as sensors, dedicated AI chips, cloud computing, distributed storage and big data processing. AI software-level technologies mainly include several main directions such as computer vision technology, voice recognition technology, natural language processing technology, machine learning/depth learning, big data processing technology, and knowledge graph technology.

### SUMMARY

According to a first aspect of the disclosure, a method for generating a sample image is provided. The method includes: obtaining an initial image size of an initial image; obtaining a plurality of reference images by processing the initial image based on different reference processing modes; obtaining an image to be processed by fusing the plurality of reference images; and determining a target sample image from images to be processed based on the initial image size.

According to a second aspect of the disclosure, an apparatus for generating a sample image is provided. The apparatus includes: a processor and a memory stored with instructions executable by the processor. The processor is configured to obtain an initial image and an initial image size of the initial image; obtain a plurality of reference images by processing the initial image based on different reference processing modes; obtain an image to be processed by fusing the plurality of reference images; and determine a target sample image from images to be processed based on the initial image size.

According to a third aspect of the disclosure, a non-transitory computer-readable storage medium having computer instructions stored thereon is provided. The computer instructions are configured to cause a computer to implement the method for generating a sample image according to the first aspect of the disclosure. The method includes: obtaining an initial image size of an initial image; obtaining a plurality of reference images by processing the initial image based on different reference processing modes; obtaining an image to be processed by fusing the plurality of reference images; and determining a target sample image from images to be processed based on the initial image size.

It should be understood that the content described in this section is not intended to identify key or important features of the embodiments of the disclosure, nor is it intended to limit the scope of the disclosure. Additional features of the disclosure will be easily understood based on the following description.

### BRIEF DESCRIPTION OF THE DRAWINGS

The drawings are used to better understand the solution and do not constitute a limitation to the disclosure, in which:

FIG. 1 is a schematic diagram of a first embodiment of the disclosure.

FIG. 2a is a schematic diagram of comparison results among a triplet instance discrimination architecture (Tida) model and other self-supervised models according to the disclosure.

FIG. 2b is a schematic diagram of model prediction comparison results based on different sample images according to the embodiments of the disclosure.

FIG. 3 is a schematic diagram of a second embodiment of the disclosure.

FIG. 4 is a schematic diagram of a third embodiment of the disclosure.

FIG. 5 is a flowchart of a method for generating a sample image according to an embodiment of the disclosure.

FIG. 6 is a schematic diagram of a fourth embodiment of the disclosure.

FIG. 7 is a schematic diagram of a fifth embodiment of the disclosure.

FIG. 8 is a block diagram of an example electronic device used to implement the method for generating a sample image according to an embodiment of the disclosure.

### DETAILED DESCRIPTION

The following describes the embodiments of the disclosure with reference to the accompanying drawings, which includes various details of the embodiments of the disclosure to facilitate understanding, which shall be considered merely exemplary. For clarity and conciseness, descriptions of well-known functions and structures are omitted in the following description.

In the related art, an initial image is usually processed by a rotation transformation mode or a color transformation mode, to generate diverse sample images. The generated sample images in the related art may lead to the semantic information loss for the initial image, without satisfying the personalized processing needs in the actual image processing scene.

FIG. 1 is a schematic diagram of a first embodiment of the disclosure.

It should be noted that the method for generating a sample image of the embodiment may be executed by an apparatus for generating a sample image, which may be implemented by software and/or hardware. The apparatus may be integrated in an electronic device, and the electronic device includes but not limited to a terminal, a server and so on.

The embodiments of the disclosure relate to the technical field of AI, and in particular to the technical fields of computer vision and deep learning.

Artificial Intelligence (AI) is a new technical science that studies and develops theories, methods, technologies and application systems for simulating, extending and expanding human intelligence.

Deep learning is to learn the inherent laws and representation levels of sample data, and the information obtained in the learning process is of great help to the interpretation of data such as text, images and sounds. The ultimate goal of deep learning is to enable machines to have the ability to analyze and learn like humans, and to recognize data such as words, images and sounds.

Computer vision refers to machine vision with the use of cameras and computers instead of human eyes to identify, track and measure targets, and further performs graphics processing to make images more suitable for human eyes to observe or transmit to instruments for detection through computer processing.

As illustrated in FIG. 1, the method for generating a sample image includes the following steps.

At S101, an initial image size of an initial image is obtained.

When the method for generating a sample image is executed, the image acquired in an initial stage may be called the initial image, and there may be one or more initial images. The initial image may be obtained by shooting using an apparatus with a shooting function such as a mobile phone and a camera. Alternatively, the initial image may also be obtained by parsing a video. For example, the initial image may be a partial video frame image extracted from a plurality of video frames included in the video, which is not limited.

The parameter for describing the size of the initial image may be referred to as the initial image size, and the initial image size may be, for example, a width and a height of the initial image, or a radius of the initial image, which is not limited.

It should be noted that, in order to realize the method for generating a sample image described in this embodiment, when a plurality of initial images are obtained, the initial image sizes of different initial images may be the same or different.

At S102, a plurality of reference images are obtained by processing the initial image based on different reference processing modes.

The mode used to process the initial image may be referred to as a reference processing mode. The reference processing mode may be, for example, a random clip, a color jitter, random erasing, and a Gaussian blur, which is not limited here.

In the embodiments of the disclosure, the reference processing mode may be a combination of at least two of the above processing modes, and the combined mode may be adaptively configured according to the needs of the actual image processing scene, which is not limited.

After the initial image is acquired, various reference processing modes may be used to process the initial image respectively, so as to obtain a plurality of processed images. The processed images may be referred to as the reference images.

That is, after the initial image is obtained, various reference processing modes may be adopted to process the initial image respectively, to obtain a plurality of reference images corresponding to the various reference processing modes. Alternatively, one or several reference processing modes may also be used to process the plurality of initial images, to obtain a plurality of reference images, which is not limited.

For example, if the initial image is initial image a, then the reference processing modes such as the random clip, color jitter, random erasing and Gaussian blur, may be used to process the initial image respectively, in order to obtain image a1 corresponding to the color jitter processing mode, image a2 corresponding to the random clip processing mode, image a3 corresponding to the random erasing processing mode, and image a4 corresponding to the Gaussian blur processing mode. The image a1, image a2, image a3, and image a4 may be determined as the reference images.

For example, if the initial images are initial image a, initial image b, initial image c and initial image d, then the initial image a, initial image b, initial image c, initial image d are processed, to obtain the image a1 corresponding to the random clip processing mode, the image b1 corresponding to the random clip processing mode, the image c1 corresponding to the random clip processing mode, and the image d1 corresponding to the random clip processing mode. The image a1, image b1, image c1, and image d1 may be determined as the reference images.

At S103, an image to be processed is obtained by fusing the plurality of reference images

The above reference processing modes are used to process the initial image respectively, to obtain the plurality of corresponding reference images, and the plurality of reference images are fused to obtain the fused image. The fused image may be referred to as the image to be processed.

Optionally, in some embodiments, fusing the plurality of reference images to obtain the image to be processed may be to perform edge splicing processing on the plurality of reference images, and determine the spliced image as the image to be processed. In this way, the problems of seaming and blurring existed in the process of image fusion may be effectively reduced, so as to achieve seamless image splicing, and the integrity of semantic information expression for the initial image may be effectively guaranteed, so that the semantic information loss at edges of the initial image may be effectively avoided and the expression effect of the overall semantic information is ensured.

The edge splicing processing refers to an image processing mode in which a plurality of reference images are seamlessly spliced into one complete image by means of edge alignment, which is not limited.

For example, if the reference images include: reference image a, reference image b, reference image c, and reference image d, and the image sizes corresponding to the four reference images are all 224*224, then edges of the reference image a, reference image b, reference image c, and reference image d are aligned in turn. That is, the plurality of reference images are seamlessly spliced based on the long side and the wide side, to form a complete image e. The image e may be called the image to be processed, and the image size corresponding to the image e may be 448*448.

At S104, a target sample image is determined from images to be processed based on the initial image size.

After the image to be processed is obtained by fusing the plurality of reference images, an image whose size is the same or different from the initial image size may be determined from the images to be processed based on the initial image size. The determined image may be referred to as the target sample image.

In some embodiments, the initial image size corresponding to the initial image may be compared with the size of the image to be processed, and if the size of the image to be processed is consistent with the initial image size, the image to be processed may be determined as the target sample image, or the target sample image may be determined from the images to be processed in any other possible way, such as random sampling, local extraction and model recognition, which is not limited here.

In the embodiment, the initial image size of the initial image is obtained, and various reference processing modes are adopted to process the initial image respectively, to obtain the plurality of reference images. The plurality of reference images are fused to obtain the image to be processed, and according to the initial image size, the target sample image is determined from the images to be processed. Therefore, the sample image generation effect may be effectively improved, so that the generated target sample image can fully represent the semantic information contained in the initial image, and the target sample image can effectively satisfy the personalized processing needs in the actual image processing scene.

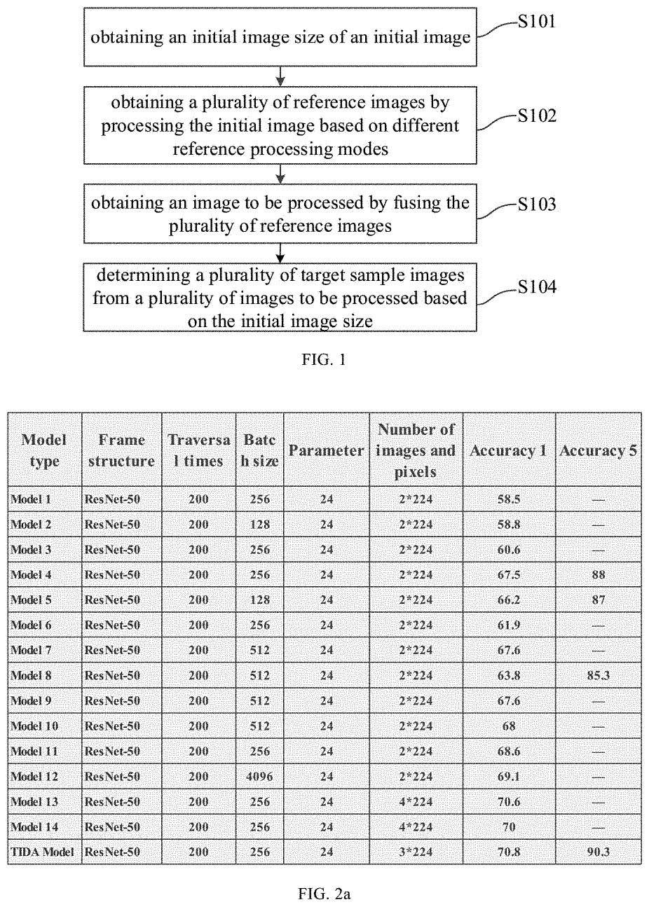

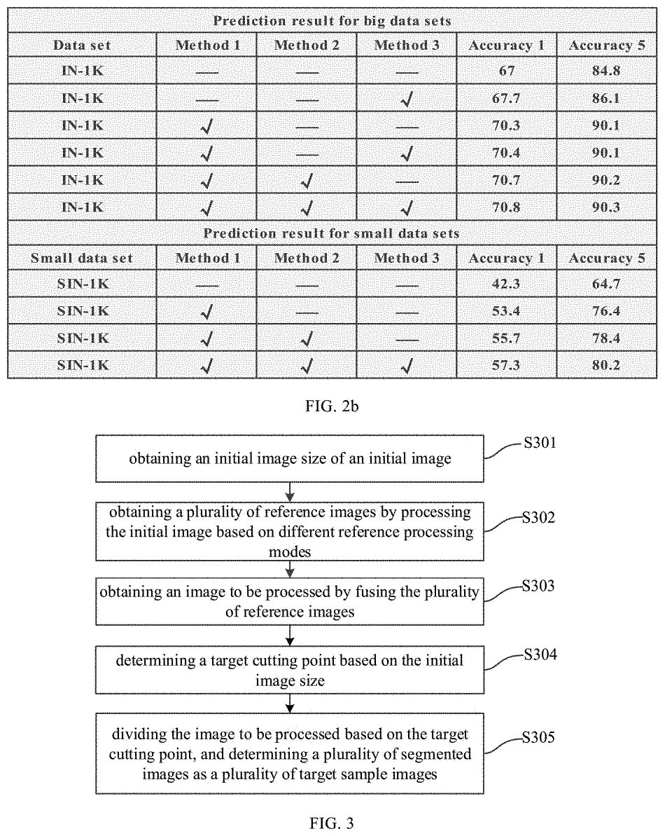

The following may take a Triplet Instance Discrimination Architecture (Tida) model as an example to describe the effect of the method for generating a sample image described in this embodiment on model prediction. As illustrated in FIGS. 2a and 2b, FIG. 2a is a schematic diagram of comparison results among the Tida model and other self-supervised models according to the disclosure. The frame structure of the model prediction may be exemplified by a convolutional neural network (Residual Network-50, ResNet-50) structure. Accuracy 1 refers to an accuracy rate of the unique predicted category result output by the model, when the model predicts the category of an image. Accuracy 5 refers to an accuracy rate of 5 predicted category results output by the model, when the model predicts the category of an image.

In FIG. 2a, model 1-model 14 may be an autoregressive model, an autoencoding model, a flow model, or a hybrid generation model in the related art, which is not limited.

FIG. 2b is a schematic diagram of model prediction comparison results based on different sample images according to the embodiments of the disclosure. FIG. 2b shows model prediction comparison results obtained by the method for generating a sample image (method 1) described in this embodiment, a negative sample sampling mechanism (method 2) and the triplet discriminant loss (method 3) under the same conditions. In order to more objectively demonstrate the prediction effects of the models, the embodiment may show the prediction results of the Tida model based on a large data set (ImageNet 1k, IN-1K) and a small data set (Small imagenet1k, SIN-1K) respectively. The data volume of the small data set is 1/10 of that of the large data set.

It may be seen from the above FIGS. 2a and 2b, the method for generating a sample image in the embodiment of the disclosure has a good model prediction effect in terms of model predictions based on both the large data set and the small data set.

FIG. 3 is a schematic diagram of a second embodiment of the disclosure.

As illustrated in FIG. 3, the method for generating a sample image includes the following steps.

At S301, an initial image size of an initial image is obtained.

At S302, a plurality of reference images are obtained by processing the initial image based on different reference processing modes.

At S303, an image to be processed is obtained by fusing the plurality of reference images.

For descriptions of S301-S303, reference may be made to the foregoing embodiments, and details are not repeated here.

At S304, a target cutting point is determined based on the initial image size.

The cutting point for dividing the initial image may be called the target cutting point.

Optionally, in some embodiments, the target cutting point is determined according to the initial image size. A target image area is determined according to the initial image size, target pixel points are randomly selected in the target image area as the target cutting point. Since the target image area is determined according to the initial image size, and the target pixel points are randomly selected in the target image area as the target cutting point, the target cutting point may be determined flexibly and conveniently, which effectively avoids introducing interference factors of subjective selection and ensures the randomness of the target cutting point, so that the target sample image determined based on the target cutting point has a more objective semantic information distribution, and the generation effect of the overall sample image is ensured.

The image area for determining the target cutting point may be referred to as the target image area.

In some embodiments, determining the target image area according to the initial image size may be to randomly select a local image area with the same size as the initial image in the image to be processed, and determine the local image area as the target image area.

For example, if the initial image size is 224*224, and the image size corresponding to the image to be processed obtained by fusion is 448*448, an area of 224*224 may be randomly selected as the target image area from the image to be processed according to the initial image size.

Pixel points are basic units that constitutes an image, that is, an image may be regarded as a set of pixel points. Correspondingly, the pixel points in the set of pixel points used to divide the target image may be called the target pixel points.

After the target image area is determined from the image to be processed, the target pixel points may be randomly selected in the target image area, and the target pixel points may be determined as the target cutting point.

That is, after the target image area is determined from the image to be processed, a pixel point may be randomly selected from the target image area (the set of pixel points constituting the target image area) and determined as the target pixel points, so that the subsequent steps of dividing the image to be processed may be performed based on the target pixel points.

At S305, the image to be processed is divided based on the target cutting point, and a plurality of segmented images are determined as a plurality of target sample images.

After the target cutting point is determined based on the initial image size, the image to be processed may be divided based on the target cutting point, so as to obtain the plurality of segmented images as the plurality of target sample images.

In some embodiments, dividing the image to be processed based on the target cutting point may be dividing the image to be processed in horizontal and vertical directions by taking the target cutting point as a center, and 4 segmented images are obtained as the target sample images. Alternatively, any other possible manner may be used to implement the step of dividing the image to be processed according to the target cutting point, which is not limited.

In this embodiment, the initial image size corresponding to the initial image are obtained, and various reference processing modes are used to process the initial image respectively, so as to obtain the plurality of corresponding reference images. The plurality of reference images are fused to obtain the image to be processed, and according to the initial image size, the target sample image is determined from the images to be processed. Therefore, the sample image generation effect may be effectively improved, so that the generated target sample image can fully represent the semantic information contained in the initial image, and the target sample image can effectively satisfy the personalized processing needs in the actual image processing scene. Since the target image area is determined based on the initial image size, and the target pixel point in the target image area is randomly selected as the target cutting point, the target cutting point may be determined flexibly and conveniently, introducing the interference factors of subjective selection may be effectively avoided, the randomness of the target cutting point is ensured, so that the target sample image determined based on the target cutting point has more objective semantic information distribution, the overall sample image generation effect is ensured. By determining the target cutting point based on the initial image size, performing the segmentation processing on the images to be processed based on the target cutting point, and determining the plurality of segmented images as the plurality of the target sample images, more accurate segmentation processing may be performed on the image to be processed based on the target cutting point, so that the effect of image segmentation may be effectively improved, and the efficiency of image segmentation may be improved.

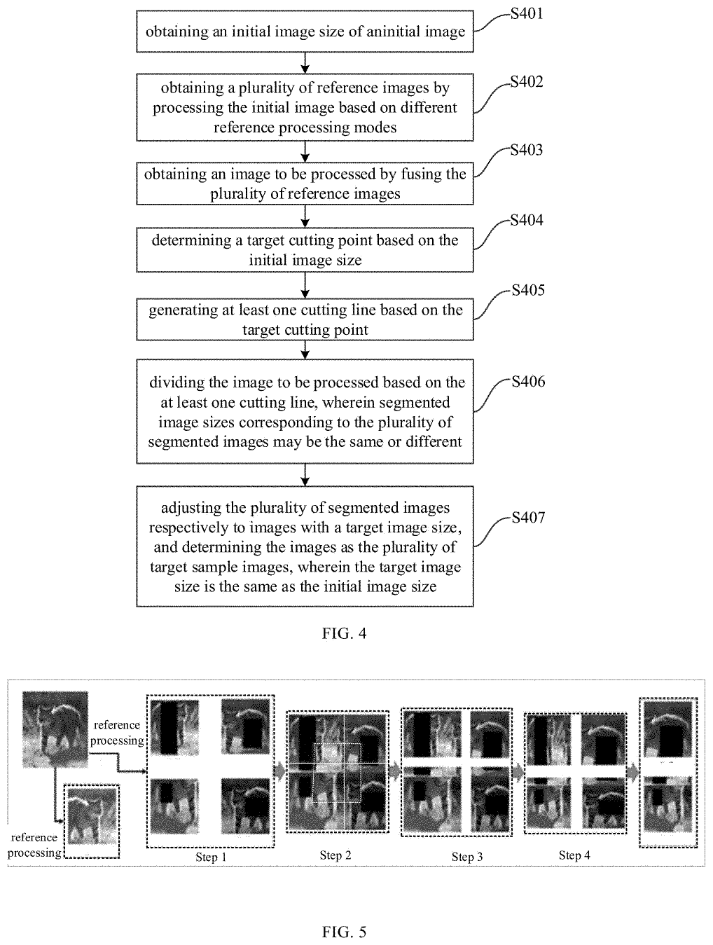

FIG. 4 is a schematic diagram of a third embodiment of the disclosure.

As illustrated in FIG. 4, the method for generating a sample image includes the following steps.

At S401, an initial image size of an initial image are obtained.

At S402, a plurality of reference images are obtained by processing the initial image based on different reference processing modes.

At S403, an image to be processed is obtained by fusing the plurality of reference images.

At S404, a target cutting point is determined based on the initial image size.

For descriptions of S401-S404, reference may be made to the foregoing embodiments, and details are not repeated here.

At S405, at least one cutting line is generated based on the target cutting point.

After the target cutting point is determined according to the initial image size, the at least one cutting line may be generated according to the target cutting point. The cutting line may be used to perform segmentation processing on the image to be processed.

In some embodiments, the cutting line is generated according to the target cutting point, a rectangular coordinate system is established in horizontal and vertical directions by taking the target cutting point as the original point. The x-axis and the y-axis of the rectangular coordinate system may be used as the dividing lines, so that the image to be processed may be divided based on the dividing lines.

Alternatively, any other possible manner may be used to perform the step of generating the at least one cutting line according to the target cutting point. For example, the cutting line may also be an arc or be of any other possible shape, which is not limited.

At S406, a plurality of segmented images are obtained by dividing the image to be processed based on the at least one cutting line. Segmented image sizes corresponding to the plurality of segmented images may be the same or different.

After the at least one cutting line is generated according to the target cutting point, the above-mentioned at least one cutting line may be used as a benchmark to perform segmentation processing on the images to be processed, thus effectively preventing the image segmentation processing logic from damaging the semantic information of the initial image and ensuring the integrity of the semantic information. The image segmentation processing logic may also be effectively simplified, and the efficiency and segmentation processing effect of the image segmentation processing may be effectively improved.

That is, after the at least one cutting line is generated according to the target cutting point, the image to be processed may be segmented along the cutting line.

For example, the target cutting point is determined as an origin to establish a rectangular coordinate system in the horizontal direction and the vertical direction, and after the x axis and the y axis are determined as the dividing lines, the image to be processed is divided along the x axis and the y axis, to obtain a plurality of segmented images divided along the x axis and the y axis.

The parameter for describing the size of the segmented image may be called the segmented image size, and the segmented image sizes corresponding to the segmented images may be the same or different.

At S407, the plurality of segmented images are respectively adjusted to images with a target image size, and the images with the target image size are determined as the plurality of target sample images. The target image size is the same as the initial image size.

The parameters for describing the size of the target sample image may be referred to as the target image size, and the target image size and the initial image size may be configured to be the same.

After the above segmentation processing is performed on the image to be processed to obtain the plurality of segmented images, the size of the segmented images may be adjusted, so that the size of the plurality of adjusted images the may be configured to be the same as the size of the initial image, and the plurality of adjusted images are the target sample images.

In some embodiments, the initial image size may be used as a benchmark, and the size of the segmented image may be adjusted using software with a picture editing function. That is, the size of the segmented images may be adjusted to the initial image size, or any other possible mode may be adopted to adjust the size of the segmented images, which is not limited.

In this embodiment, the initial image size are obtained, various reference processing modes are used to process the initial image respectively to obtain the plurality of reference images. The plurality of reference images are fused to obtain the image to be processed, and the target sample image is determined from the image to be processed according to the initial image size. Therefore, the effect of sample image generation may be effectively improved, so that the generated target sample image can fully represent the semantic information contained in the initial image, and the target sample image can effectively satisfy the personalized processing needs in actual image processing scenes. The segmentation processing is performed on the image to be processed based on the target cutting point, to obtain the plurality of segmented images. The segmented image sizes corresponding to the plurality of segmented images may be the same or different. The plurality of segmented images are adjusted to images with the target image size as the plurality of target sample images, in which the target image size is the same as the initial image size. Since the image size corresponding to the plurality of segmented images is adjusted to the initial image size, the generated plurality of target sample images may be effectively adapted to the individual needs of the model training for the image size. In addition, it is also possible to perform the method for generating a sample image described in this embodiment again based on the plurality of segmented images obtained by adjustment, which can effectively assist in the expansion of the sample images, thus solving the technical problem of insufficient utilization of image semantic information.

As illustrated in FIG. 5, FIG. 5 is a flowchart of a method for generating a sample image according to an embodiment of the disclosure. Firstly, various reference processing modes may be used to process the initial image, to obtain 4 reference images (which may be other number). The plurality of reference images may be fused to obtain the images to be processed, the target image area (as shown by the dotted line box in the figure) is determined from the image to be processed according to the initial image size. The target cutting point is selected in the target image area, two cutting lines are generated according to the target cutting point. The image to be processed is divided into 4 segmented images by taking the two dividing lines as a benchmark. Based on the initial image size, the size of the 4 segmented images is adjusted to the initial image size, to obtain the target sample images.

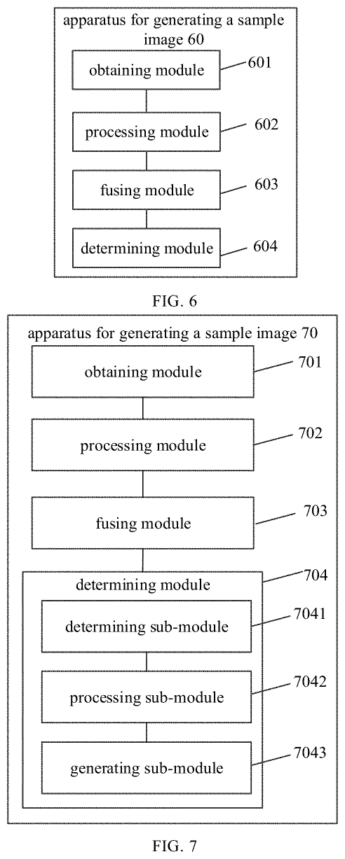

FIG. 6 is a schematic diagram of a fourth embodiment according to the disclosure.

As illustrated in FIG. 6, an apparatus for generating a sample image 60 includes: an obtaining module 601, a processing module 602, a fusing module 603 and a determining module 604.

The obtaining module 601 is configured to obtain an initial image size of an initial image.

The processing module 602 is configured to obtain a plurality of reference images by processing the initial image based on different reference processing modes.

The fusing module 603 is configured to obtain an image to be processed by fusing the plurality of reference images.

The determining module 604 is configured to determine a plurality of target sample images from a plurality of images to be processed based on the initial image size.

In an embodiment of the disclosure, FIG. 7 is a schematic diagram of a fifth embodiment according to the disclosure. As illustrated in FIG. 7, an apparatus for generating a sample image 70 includes: an obtaining module 701, a processing module 702, a fusing module 703 and a determining module 704.

The fusing module 703 is configured to: perform edge splicing processing to the plurality of reference images, and determine a plurality of spliced images as the image to be processed.

In some embodiments of the disclosure, the determining module 704 includes: a determining sub-module 7041 and a processing sub-module 7042.

The determining sub-module 7041 is configured to determine a target cutting point based on the initial image size.

The processing sub-module 7042 is configured to divide the image to be processed based on the target cutting point, and determine a plurality of segmented images as a plurality of target sample images.

In some embodiments of the disclosure, the processing sub-module 7042 is further configured to: obtain a plurality of segmented images by dividing the image to be processed based on the target cutting point, in which segmented image sizes corresponding to the plurality of segmented images may be the same or different; and adjust the plurality of segmented images respectively to images with a target image size, and determine the images with the target image size as the plurality of target sample images, in which the target image size is the same as the initial image size.

In some embodiments of the disclosure, the determining module 704 further includes: a generating sub-module 7043, configured to, after determining the target cutting point based on the initial image size, generate at least one cutting line based on the target cutting point.

The processing sub-module 7042 is further configured to divide the image to be processed based on the at least one cutting line.

In some embodiments of the disclosure, the determining sub-module 7041 is further configured to: determine a target image area based on the initial image size; and select a target pixel point randomly in the target image area, and determine the target pixel point as the target cutting point.

It should be understood that the apparatus for generating a sample image 70 in FIG. 7 and the apparatus for generating a sample image 60 in the above-mentioned embodiments, the obtaining module 701 and the obtaining module 601 in the above embodiments, and the processing module 702 and the processing module 602 in the above embodiments, the fusing module 703 and the fusing module 603 in the above embodiments, and the determining module 704 and the determining module 604 in the above embodiments may have the same function and structure.

It should be noted that the foregoing explanations on the method for generating a sample image are also applicable to the apparatus for generating a sample image of this embodiment, which are not repeated here.

In the embodiment, the initial image and the initial image size of the initial image are obtained. The plurality of reference images are obtained by processing the initial image based on different reference processing modes. The plurality of images to be processed are obtained by fusing the plurality of reference images. The plurality of target sample images are determined from the plurality of images to be processed based on the initial image size of the initial image. In this way, the effect of generating a sample image may be effectively improved, so that the generated target sample image can fully represent the semantic information contained in the initial image, and the target sample image can effectively satisfy the personalized processing needs in the actual image processing scene.

According to the embodiments of the disclosure, the disclosure also provides an electronic device, a readable storage medium and a computer program product.

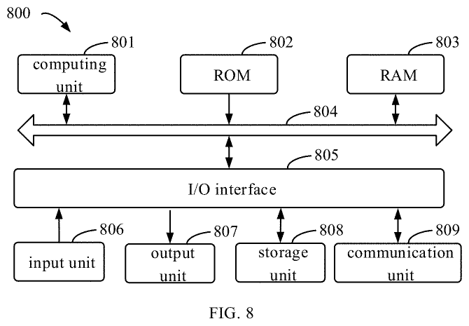

FIG. 8 is a block diagram of an electronic device used to implement the method for generating a sample image according to the embodiments of the disclosure. Electronic devices are intended to represent various forms of digital computers, such as laptop computers, desktop computers, workbenches, personal digital assistants, servers, blade servers, mainframe computers, and other suitable computers. Electronic devices may also represent various forms of mobile devices, such as personal digital processing, cellular phones, smart phones, wearable devices, and other similar computing devices. The components shown here, their connections and relations, and their functions are merely examples, and are not intended to limit the implementation of the disclosure described and/or required herein.

As illustrated in FIG. 8, the device 800 includes a computing unit 801 performing various appropriate actions and processes based on computer programs stored in a read-only memory (ROM) 802 or computer programs loaded from the storage unit 808 to a random access memory (RAM) 803. In the RAM 803, various programs and data required for the operation of the device 800 are stored. The computing unit 801, the ROM 802, and the RAM 803 are connected to each other through a bus 804. An input/output (I/O) interface 805 is also connected to the bus 804.

Components in the device 800 are connected to the I/O interface 805, including: an inputting unit 806, such as a keyboard, a mouse; an outputting unit 807, such as various types of displays, speakers; a storage unit 808, such as a disk, an optical disk; and a communication unit 809, such as network cards, modems, and wireless communication transceivers. The communication unit 809 allows the device 800 to exchange information/data with other devices through a computer network such as the Internet and/or various telecommunication networks.

The computing unit 801 may be various general-purpose and/or dedicated processing components with processing and computing capabilities. Some examples of computing unit 801 include, but are not limited to, a central processing unit (CPU), a graphics processing unit (GPU), various dedicated AI computing chips, various computing units that run machine learning model algorithms, and a digital signal processor (DSP), and any appropriate processor, controller and microcontroller. The computing unit 801 executes the various methods and processes described above, such as the method for generating a sample image. For example, in some embodiments, the method may be implemented as a computer software program, which is tangibly contained in a machine-readable medium, such as the storage unit 808. In some embodiments, part or all of the computer program may be loaded and/or installed on the device 800 via the ROM 802 and/or the communication unit 809. When the computer program is loaded on the RAM 803 and executed by the computing unit 801, one or more steps of the method described above may be executed. Alternatively, in other embodiments, the computing unit 801 may be configured to perform the method in any other suitable manner (for example, by means of firmware).

Various implementations of the systems and techniques described above may be implemented by a digital electronic circuit system, an integrated circuit system, Field Programmable Gate Arrays (FPGAs), Application Specific Integrated Circuits (ASICs), Application Specific Standard Products (ASSPs), System on Chip (SOCs), Load programmable logic devices (CPLDs), computer hardware, firmware, software, and/or a combination thereof. These various embodiments may be implemented in one or more computer programs, the one or more computer programs may be executed and/or interpreted on a programmable system including at least one programmable processor, which may be a dedicated or general programmable processor for receiving data and instructions from the storage system, at least one input device and at least one output device, and transmitting the data and instructions to the storage system, the at least one input device and the at least one output device.

The program code configured to implement the method of the disclosure may be written in any combination of one or more programming languages. These program codes may be provided to the processors or controllers of general-purpose computers, dedicated computers, or other programmable data processing devices, so that the program codes, when executed by the processors or controllers, enable the functions/operations specified in the flowchart and/or block diagram to be implemented. The program code may be executed entirely on the machine, partly executed on the machine, partly executed on the machine and partly executed on the remote machine as an independent software package, or entirely executed on the remote machine or server.

In the context of the disclosure, a machine-readable medium may be a tangible medium that may contain or store a program for use by or in connection with an instruction execution system, apparatus, or device. The machine-readable medium may be a machine-readable signal medium or a machine-readable storage medium. A machine-readable medium may include, but is not limited to, an electronic, magnetic, optical, electromagnetic, infrared, or semiconductor system, apparatus, or device, or any suitable combination of the foregoing. More specific examples of machine-readable storage media include electrical connections based on one or more wires, portable computer disks, hard disks, random access memories (RAM), read-only memories (ROM), electrically programmable read-only-memory (EPROM), flash memory, fiber optics, compact disc read-only memories (CD-ROM), optical storage devices, magnetic storage devices, or any suitable combination of the foregoing.

In order to provide interaction with a user, the systems and techniques described herein may be implemented on a computer having a display device (e.g., a Cathode Ray Tube (CRT) or a Liquid Crystal Display (LCD) monitor for displaying information to a user); and a keyboard and pointing device (such as a mouse or trackball) through which the user can provide input to the computer. Other kinds of devices may also be used to provide interaction with the user. For example, the feedback provided to the user may be any form of sensory feedback (e.g., visual feedback, auditory feedback, or haptic feedback), and the input from the user may be received in any form (including acoustic input, voice input, or tactile input).

The systems and technologies described herein may be implemented in a computing system that includes background components (for example, a data server), or a computing system that includes middleware components (for example, an application server), or a computing system that includes front-end components (for example, a user computer with a graphical user interface or a web browser, through which the user can interact with the implementation of the systems and technologies described herein), or include such background components, intermediate computing components, or any combination of front-end components. The components of the system may be interconnected by any form or medium of digital data communication (e.g., a communication network). Examples of communication networks include: local area network (LAN), wide area network (WAN), the Internet and Block-chain network.

The computer system may include a client and a server. The client and server are generally remote from each other and interacting through a communication network. The client-server relation is generated by computer programs running on the respective computers and having a client-server relation with each other. The server may be a cloud server, also known as a cloud computing server or a cloud host, which is a host product in the cloud computing service system, to solve the problems of difficult management and weak service scalability existing in traditional physical hosts and virtual private server (VPS) services. The server may also be a server of a distributed system, or a server combined with a block-chain.

It should be understood that the various forms of processes shown above may be used to reorder, add or delete steps. For example, the steps described in the disclosure could be performed in parallel, sequentially, or in a different order, as long as the desired result of the technical solution disclosed in the disclosure is achieved, which is not limited herein.

The above specific embodiments do not constitute a limitation on the protection scope of the disclosure. Those skilled in the art should understand that various modifications, combinations, sub-combinations and substitutions may be made according to design requirements and other factors. Any modification, equivalent replacement and improvement made within the spirit and principle of the disclosure shall be included in the protection scope of the disclosure.

What is claimed is:

1. A method for generating a sample image, comprising:
obtaining an initial image size of an initial image;
obtaining a plurality of reference images by processing the initial image based on different reference processing modes;
obtaining an image to be processed by fusing the plurality of reference images; and
determining a target sample image from images to be processed based on the initial image size.

2. The method of claim 1, wherein obtaining the image to be processed by fusing the plurality of reference images comprises:
performing edge splicing processing to the plurality of reference images, and determining a spliced image as the image to be processed.

3. The method of claim 1, wherein determining the target sample image from the images to be processed comprises:
determining a target cutting point based on the initial image size; and
dividing the image to be processed based on the target cutting point, and determining a plurality of segmented images as a plurality of target sample images.

4. The method of claim 3, wherein dividing the image to be processed based on the target cutting point and determining the plurality of segmented images as the plurality of target sample images comprises:
obtaining a plurality of segmented images by dividing the image to be processed based on the target cutting point, wherein segmented image sizes corresponding to the plurality of segmented images may be the same or different; and
adjusting the plurality of segmented images respectively to images with a target image size, and determining the images with the target image size as the plurality of target sample images, wherein the target image size is the same as the initial image size.

5. The method of claim 3, further comprising:
generating at least one cutting line based on the target cutting point; and
dividing the image to be processed dividing the image to be processed with the at least one cutting line.

6. The method of claim 3, wherein determining the target cutting point comprises:
determining a target image area based on the initial image size; and
selecting a target pixel point randomly in the target image area, and determining the target pixel point as the target cutting point.

7. An apparatus for generating a sample image, comprising:
a processor; and
a memory stored with instructions executable by the processor;
wherein the processor is configured to:
obtain an initial image size of an initial image;
obtain a plurality of reference images by processing the initial image based on different reference processing modes;
obtain an image to be processed by fusing the plurality of reference images; and
determine a target sample image from images to be processed based on the initial image size.

8. The apparatus of claim 7, wherein the processor is further configured to:
perform edge splicing processing to the plurality of reference images, and determining a spliced image as the image to be processed.

9. The apparatus of claim 7, wherein the processor is further configured to:
determine a target cutting point based on the initial image size; and
divide the image to be processed based on the target cutting point, and determine the plurality of segmented images as a plurality of target sample images.

10. The apparatus of claim 9, wherein the processer is further configured to:
obtain a plurality of segmented images by dividing the image to be processed based on the target cutting point, wherein segmented image sizes corresponding to the plurality of segmented images may be the same or different; and
adjust the plurality of segmented images respectively to images with a target image size, and determining the images with the target image size as the plurality of target sample images, wherein the target image size is the same as the initial image size.

11. The apparatus of claim 9, wherein the processor is further configured to:
generate at least one cutting line based on the target cutting point;
divide the image to be processed with the at least one cutting line.

12. The apparatus of claim 9, wherein the processor is further configured to:
determine a target image area based on the initial image size; and
select a target pixel point randomly in the target image area, and determining the target pixel point as the target cutting point.

13. A non-transitory computer-readable storage medium storing computer instructions, wherein when the instructions are executed by a computer, a method for generating a sample image is executed, the method comprising:
obtaining an initial image size of an initial image;
obtaining a plurality of reference images by processing the initial image based on different reference processing modes;
obtaining an image to be processed by fusing the plurality of reference images; and
determining a target sample image from images to be processed based on the initial image size.

14. The storage medium of claim 13, wherein obtaining the image to be processed by fusing the plurality of reference images comprises:
performing edge splicing processing to the plurality of reference images, and determining a spliced image as the image to be processed.

15. The storage medium of claim 13, wherein determining the target sample image from the images to be processed comprises:
determining a target cutting point based on the initial image size; and
dividing the image to be processed based on the target cutting point, and determining a plurality of segmented images as a plurality of target sample images.

16. The storage medium of claim 15, wherein dividing the image to be processed based on the target cutting point and determining the plurality of segmented images as the plurality of target sample images comprises:
obtaining a plurality of segmented images by dividing the image to be processed based on the target cutting point, wherein segmented image sizes corresponding to the plurality of segmented images may be the same or different; and
adjusting the plurality of segmented images respectively to images with a target image size, and determining the images with the target image size as the plurality of target sample images, wherein the target image size is the same as the initial image size.

17. The storage medium of claim 15, further comprising:
generating at least one cutting line based on the target cutting point; and
dividing the image to be processed dividing the image to be processed with the at least one cutting line.

18. The storage medium of claim 15, wherein determining the target cutting point comprises:
determining a target image area based on the initial image size; and
selecting a target pixel point randomly in the target image area, and determining the target pixel point as the target cutting point.
